(19) United States
(12) Patent Application Publication
(10) Pub. No.: US 2006/0140440 A1
(43) Pub. Date: Jun. 29, 2006

(54) Reversible watermarking of digital signals

(76) Inventors: Minne Van Der Veen, Eindhoven (NL); Alphons Antonius Maria Lambertus Bruekers, Eindhoven (NL); Adriaan Johan Van Leest, Eindhoven (NL); Stephane Cavin, St. Sulpice (CH)

Correspondence Address: PHILIPS INTELLECTUAL PROPERTY & STANDARDS, P.O. BOX 3001, BRIARCLIFF MANOR, NY, 10510, US

(21) Appl. No.: 10/542,139

(22) PCT Filed: Jan. 13, 2004
(86) PCT No.: PCT/IB04/50009

§ 371 Date: Jul. 12, 2005

(30) Foreign Application Priority Data
Jan. 17, 2003 (EP) 03100093.8

(51) Int. Cl. G06K 9/00

(52) U.S. Cl. 382/100

(57) ABSTRACT

The invention relates to methods, devices, a system of devices and a signal where additional information is embedded in media content. The system includes a device (10) providing additional information (O, D) in a signal (y) having media content, comprising a first mapping unit (14) mapping the amplitude values of the media content onto first new values, and a multiplexing unit (16) inserting the additional information into the mapped media content. The system also includes a device (12) for receiving additional information (O, D) in a signal (y) having media content, comprising a demultiplexing unit (22) arranged to receive a signal including media content (x_{Q}) the amplitude values of which have been mapped onto first new values together with additional embedded information (O, D), and remove the additional information from the mapped media content. The invention allows insertion of watermarks into media content such as audio.

### TECHNICAL FIELD

The present invention generally relates to the field of providing additional information in media content, which has been mapped for allowing insertion of additional information. The invention is more particularly related to providing reversible watermarking in signals comprising media content.

### DESCRIPTION OF RELATED ART

It is known to provide additional information in relation to media content. One such instance is within the field of watermarking, where information is embedded in a media file, like for instance in a digital image. The watermark can then be retrieved from the image and used for different purposes. It is furthermore also known with reversible watermarking in the field of images, where the original image can be restored after removal of the watermark. A principal advantage of these schemes is that the bandwidth of the communication channel (i.e. the media file) does not need to be increased. I.e. it is an in-band information channel. One such technique is described by J. Fridrich, M. Goljan, and R. Du in “Lossless data embedding for all image formats”, Proc. SPIE Photonics West, Vol. 4675, Security and Watermarking of Multimedia Contents, San Jose, Calif., January 2002, pp. 572-583.

There is however a need for an alternative technique where additional information, perhaps in the form of watermarks, can be added to media content in a way, that allows the avoiding of loss of information in the original media content and that can also be used for audio while allowing a higher data capacity for the additional information.

### SUMMARY OF THE INVENTION

It is thus an object of the present invention to provide additional information in a signal having media content, which allows the avoiding of loss of information in the original media content and can be used for audio while allowing a high data capacity for the additional information.

According to a first aspect of the present invention, this object is achieved by a method of sending additional information in a signal having media content comprising the steps of:

mapping the amplitude values of the media content onto first new values using a first mapping function, and

inserting the additional information into the mapped media content.

According to a second aspect of the present invention, this object is also achieved by a method of receiving additional information in a signal having media content, comprising the steps of:

receiving a signal including media content the amplitude values of which have been mapped onto first new values using a first mapping function together with embedded additional information, and

removing the additional information from the media content.

According to a third aspect of the present invention, this object is furthermore achieved by a device providing additional information in a signal having media content, comprising:

a first mapping unit arranged to map the amplitude values of the media content onto first new values using a first mapping function, and

a multiplexing unit for inserting the additional information into the mapped media content.

According to a fourth aspect of the present invention, this object is also achieved by a device for receiving additional information in a signal having media content, comprising:

a demultiplexing unit arranged to:

receive a signal including media content the amplitude values of which have been mapped onto first new values using a first mapping function together with additional information, and

remove the additional information from the media content.

According to a fifth aspect of the present invention, this object is also achieved by a system of devices that can communicate with each other comprising:

a device providing additional information in a signal having media content, comprising:

a first mapping unit arranged to map the amplitude values of the media content onto first new values using a first mapping function, and

a multiplexing unit for inserting the additional information into the mapped media content, and

a device for receiving additional information in a signal having media content, comprising:

a demultiplexing unit arranged to receive a signal including media content the amplitude values of which have been mapped onto first new values using said first mapping function together with embedded additional information, and remove the additional information from the media content.

According to a sixth aspect of the present invention, this object is also achieved by a signal comprising media content with embedded additional information, where the amplitude values of the media content have been mapped onto new values using a first mapping function, such that the additional information can be retrieved from the mapped media content.

Claims 2 and 18 are directed towards providing at least one hole in the amplitude levels of the mapped media content, which is used for inserting additional information.

Claims 3 and 19 are directed towards using a hole and a corresponding value of the mapped media content for inserting additional information in the media content.

Claims 4, 15, 20 and 26 are directed towards using an error signal for allowing restoration of the original media content essentially without losses.

Claims 7 and 16 are directed towards providing information enabling selection of a second mapping function for restoration of original media content.

Claims 9 and 22 are directed towards providing at least two different first mapping functions to be used for the media content.

Claim 10 is directed towards selecting first mapping function based on the properties of the media content.

Claims 11 and 23 are directed towards providing at least two different second mapping functions for mapping media content for which the amplitude values have been mapped onto first new values using at least two first mapping functions.

The present invention has the advantage of providing a way to embed additional information, like watermarks, in media content that allows restoring of the original media content after removing the embedded information, that has a large possible data capacity for the additional information, is well suited for audio applications, and where the additional information is hardly perceptible in the media content.

The general idea behind the invention is thus to provide additional information, in media content, like an audio signal, of which the amplitude values have been mapped on new values.

These and other aspects of the invention will be apparent from and elucidated with reference to the embodiments described hereinafter.

### BRIEF DESCRIPTION OF THE DRAWINGS

The present invention will now be explained in more detail in relation to the enclosed drawings, where

FIG. 1 shows a block schematic of an encoder and a decoder according to a first embodiment of the invention,

FIGS. 2A-2C show charts showing exemplifying first and second mapping functions as well as error signals generated by an encoder according to the invention,

FIG. 3 shows a flow chart of a method of embedding an audio signal with a watermark according to the invention,

FIG. 4 shows a flow chart of a method of extracting a watermark from an audio signal according to the invention,

FIG. 5 shows a block schematic of an encoder and a decoder according to a special variation of the first embodiment of the invention,

FIGS. 6A-6B show charts showing two other exemplifying first and second mapping functions generated by an encoder according to the invention suitable for use in the encoder and decoder in FIG. 5,

FIG. 7 shows the general form of a signal according to the invention as used in the second embodiment,

FIG. 8 shows a block schematic of an encoder according to a second embodiment of the present invention,

FIG. 9 shows a block schematic of an encoder according to a third embodiment of the present invention, and

FIG. 10 shows a block schematic of an encoder according to a fourth embodiment of the present invention.

### DETAILED DESCRIPTION OF EMBODIMENTS

The present invention relates to the field of providing additional information in relation to a signal comprising media content. One preferred area of use is the area of reversible watermarking of audio streams. The invention is however not limited to this area, but can be used in many other different fields of technology and for other types of signals like for instance digital images.

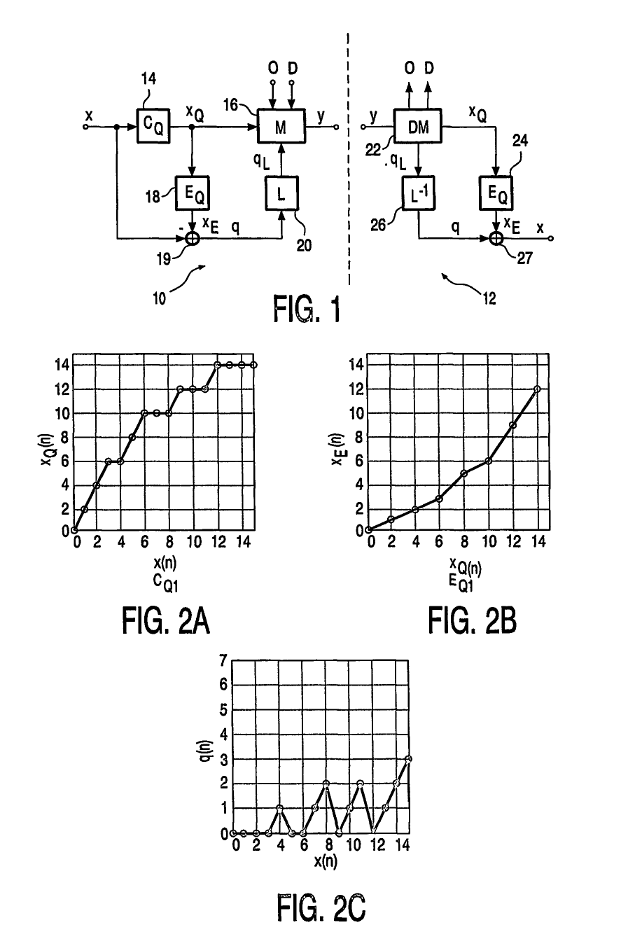

FIG. 1 schematically shows an encoder 10, which is communicating with a decoder 12 via an interface. The interface is indicated with a dashed vertical line. The interface can be such a thing as the Internet or an intranet, but need not be such a network. It can for instance also be a telephone network, either fixed or wireless. The encoder 10 inserts a watermark D into a digital data stream, which in this example is an audio stream x. The actual functioning of the encoder will be described shortly. The encoder 10 includes a first mapping unit 14, which receives media content in the form of PCM samples of audio x on its input. The encoder uses a first mapping function C_{Q} of a first type, which can be a compressing function, although the invention is not limited to compressing functions. The output of the first mapping unit 14 is connected to the input of a second mapping unit 18 using a second mapping function E_{Q} of a second type, which can be an expanding function, although the invention is not limited to expanding functions. The output of the first mapping unit 14 is also connected to a first input of a multiplexing unit 16. The output of the second mapping unit 18 is connected to a subtracting unit 19, which subtracting unit also receives the input samples of the original audio signal x. The subtracting unit 19 is furthermore connected to the input of an error compressing unit 20 applying error signal compression L. The output of the error compressing unit 20 is connected to a second input of the multiplexing unit 16. The multiplexing unit also has a third input receiving overhead data O and a fourth input receiving the watermark or additional data D. The multiplexing unit 16 also has an output on which an output signal y including audio, where amplitude values have been mapped onto new values and is provided together with the watermark.

As mentioned above, FIG. 1 also includes a decoder 12. The decoder includes a demultiplexing unit 22, having an input on which it receives the signal y. The demultiplexing unit has a first output connected to a third mapping unit 24 applying a second mapping function E_{Q}. The demultiplexing unit has a second output connected to an error expanding unit 26 applying an error expanding function L⁻¹, which is the inverse of the previously mentioned error compressing function L. The demultiplexing unit 22 has a third output on which the watermark D is provided and a fourth output on which overhead data O is provided. The output of the third mapping unit 24 is connected to an adding unit 27, to which adding unit also the output of the error expanding unit 26 is connected. From this adding unit a restored original signal x is provided.

FIGS. 2A-2C show three charts, where FIG. 2A outlines the mapping of input signal samples x(n) onto output signal samples x_{Q}(n) in the form of first new values according to a first mapping function C_{Q1}, FIG. 2B outlines the mapping of input signal samples x_{Q}(n) in the form of first new values onto output samples x(n) in the form of second new values according to a second mapping function E_{Q1} and FIG. 2C outlines an error signal q(n) depending on the input signal x(n).

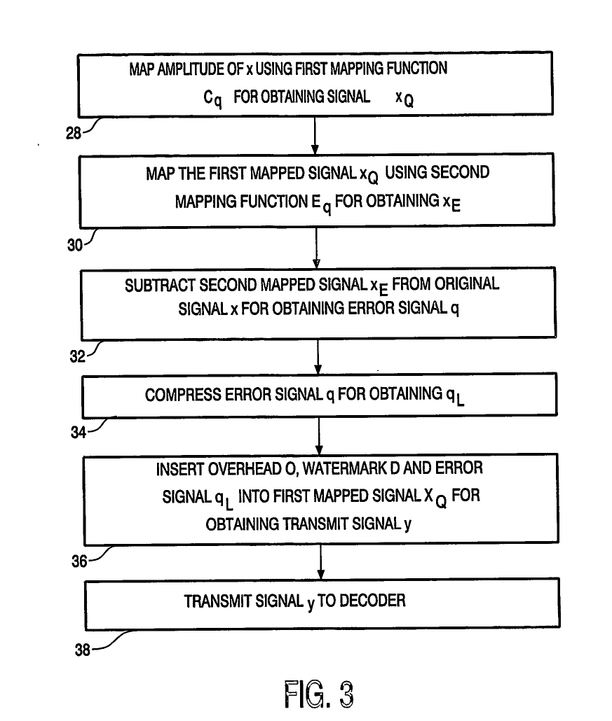

Embedding or insertion of a watermark into media content in the form of an audio signal or audio stream according to a first embodiment of the invention will now be explained with reference being made to FIGS. 1, 2 and 3, where FIG. 3 shows a flow chart of a method according to the invention. First digital PCM (Pulse Code Modulation) samples of an audio signal are received in the encoder 10. These could be received from any type of application like an audio playing device, for instance a CD-player or from a telephone application. They could also be retrieved from a store where for instance audio files are stored. The amplitude of the different samples x are then mapped onto new values using a first mapping function C_{Q} for obtaining a signal x_{Q} comprising the samples, step 28. In this first embodiment a first mapping function C_{Q1} will be used.

In FIG. 2A is shown a chart showing this first mapping function C_{Q1} according to the invention. The mapping function maps input samples of an input signal onto output samples. According to this specific scheme input amplitudes of 16 levels are mapped onto output amplitudes of 8 levels. An input amplitude level zero is mapped onto an output level zero, an input amplitude level one is mapped onto an output amplitude level two, an input amplitude level two is mapped onto an output amplitude level four. So far there has been a one to one correspondence between the original samples and the mapped samples. An input amplitude level three is mapped onto an output amplitude level six while an input amplitude level four is also mapped onto the output amplitude level six. An input amplitude level five is mapped onto an output amplitude level eight, while an input amplitude level six is mapped onto an output amplitude level ten. Also input amplitude levels seven and eight are mapped onto the output amplitude level ten. Input amplitude levels 9, 10 and 11 are mapped onto an output amplitude level twelve and input amplitude levels 12, 13, 14 and 15 are mapped onto an output amplitude level fourteen. The output signal x_{Q} having been mapped with the first mapping function thus only has eight different possible amplitude levels or values and where every odd level is not used. Every odd level therefore constitutes a hole in the mapped media content. This means that the odd levels can be used for additional information. Since some input levels share the same output level there is furthermore no one to one correspondence between input amplitude level and output amplitude level

The first mapped signal x_{Q} is then mapped again in the second mapping unit 18 using a second mapping function E_{Q} for obtaining a second new values x_{E} of the media content, step 30.

The second mapping is in this first embodiment performed using a second mapping function E_{Q1} shown using the exemplifying chart FIG. 2B. An input level zero is here mapped onto an output level zero, an input level two is mapped onto an output level one, an input level four is mapped onto an output level two, an input level six is mapped onto an output level three, an input level eight is mapped onto an output level five, an input level ten is mapped onto an output level six, an input level twelve is mapped onto an output level nine and an input level fourteen is mapped onto an output level twelve. As can be seen here all the levels of the input signal x are not present in the second new signal x_{E}.

If a simple second mapping of the first mapped signal x_{Q} were to be used alone, that would mean that some information might be lost when using this second mapping function. The second mapped signal x_{E} is therefore supplied to a subtracting unit 19, which unit 19 also receives the original signal x. The subtracting unit subtracts the second mapped signal x_{E} from the original signal x for obtaining a companding error signal q, step 32. The correspondence between the error signal q(n) and the different amplitude levels of the original input signal x(n) is shown in FIG. 2C. Because of the one-to one correspondence between the original levels zero—three and the first mapped levels, the error signal q is zero for these levels, while it is one for level four and zero again for the levels five and six. The error signal is one for level seven and two for level eight. The error is furthermore zero for level nine, one for level ten and two for level eleven. Finally the error q(n) is zero for level twelve, one for level thirteen, two for level fourteen and three for level fifteen. The error signal q is then supplied to the error compressing unit 20 applying a compressing function L onto the error signal for obtaining a compressed error signal q_{L}, step 34. This compressed error signal is submitted to the multiplexing unit 16 along with the input signal x_{Q} mapped according to the first mapping function, overhead data D and additional information or data in the form of a watermark D.

The multiplexing unit 16 then inserts or embeds the, possibly compressed, companding error signal q_{L}, some overhead information O and the watermark D into the positions made free by the first mapping function x_{Q} of the original signal x, i.e. in the odd samples of the mapped signal x_{Q}, for obtaining the transmit signal y, step 36, and transmits the signal y to the decoder 12, step 38. To explain the method of adding the additional data it is convenient to look at the process from a histogram perspective. After applying the first mapping function, the original signal with corresponding histogram is transformed in a different one with corresponding mapped histogram. The mapped histogram will have sample values with zero entries. I.e. these particular samples do not occur in the transformed signal. For the remainder we define these positions as holes. The additional information is added by using a combination of hole and another new mapped value corresponding to the hole. This means that for a given sample of the media content an additional piece of information in the form of a “one” is added by changing the mapped even level to a corresponding uneven or odd level and a zero is added by keeping the mapped level unchanged. In this first embodiment each even level will have a corresponding hole and therefore a bit of additional information can be added to each sample. By a mapped level and a corresponding hole is meant that for instance that level zero of the signal x_{Q} would correspond to the hole at level one. Every time a mapped sample having level zero is arriving at the multiplexing unit 16, this unit will change the level of the sample to level 1 when inserting a “one” and keep it unchanged when inserting a “zero” of additional information. The overhead O may include information that is used for allowing decoding or information that makes the decoding efficient. The overhead may furthermore include information such as frame size and synchronisation words if the input signal is divided into frames. It can also include CRC or error correcting information or a pointer that indicates position of different data portions in the embedded bitstream.

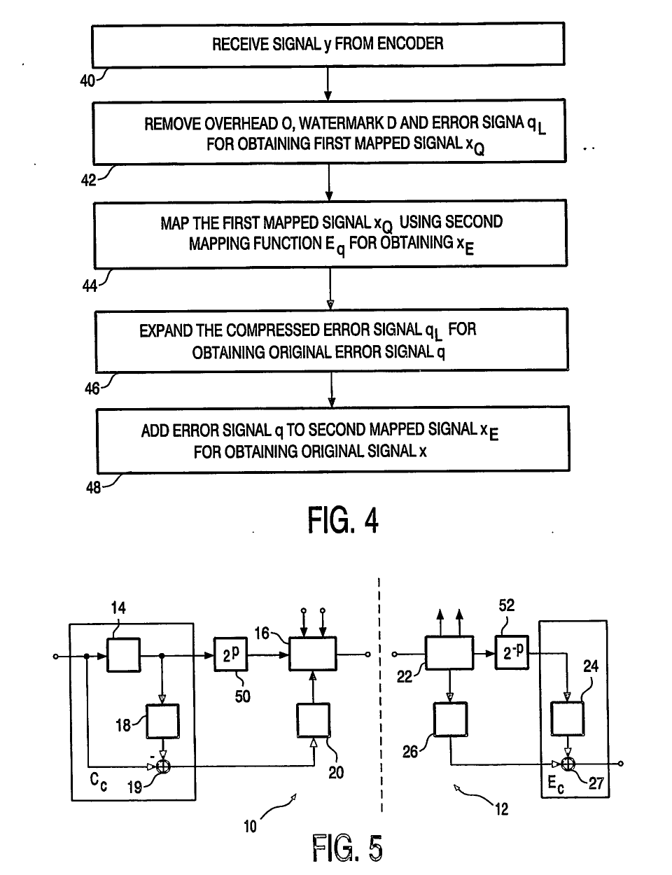

Now the processing in the decoder will be described with reference made to FIGS. 1, 2 and 4, where FIG. 4 shows a flow chart of a method of decoding a signal according to the invention. The decoder 12 receives the signal y sent from the encoder 10 on an input of the demultiplexing unit 22, step 40. The demultiplexing unit 22 extracts the embedded overhead information O, the watermark D and the, possibly compressed, companding error signal q_{L} for obtaining the audio signal x_{Q} mapped according to the first mapping function without the added information, step 42. The first mapped amplitude levels, which have received a “one”-bit of additional information and are thus odd, then receive their corresponding even amplitude level after the additional information has been extracted. The overhead O and the watermark D are then processed in a suitable manner. The audio signal x_{Q} mapped according to the first mapping function is submitted to a third mapping unit 24, which uses the second mapping function E_{Q}, and in this example the same second mapping function E_{Q1} as the second mapping unit 20 in the encoder 10 used for providing a signal x_{E} mapped according to the second mapping function, step 44. The compressed error signal q_{L} is at the same time provided to the error expanding unit 26 which applies an expanding function L⁻¹ to the compressed error signal q_{L} for obtaining the original error signal q, step 46. The expanding function is the inverse of the compressing function used on the encoder side. The retrieved error signal q is then supplied to the adding unit 27 together with the signal x_{E} mapped according to the second mapping function, where these two signals are added to each other for providing the original audio signal x, step 48. In this way a watermark has been added to an audio signal, which has been mapped according to the first mapping function, and both the watermark and the original audio signal have been restored, and the audio signal is retrieved without losses.

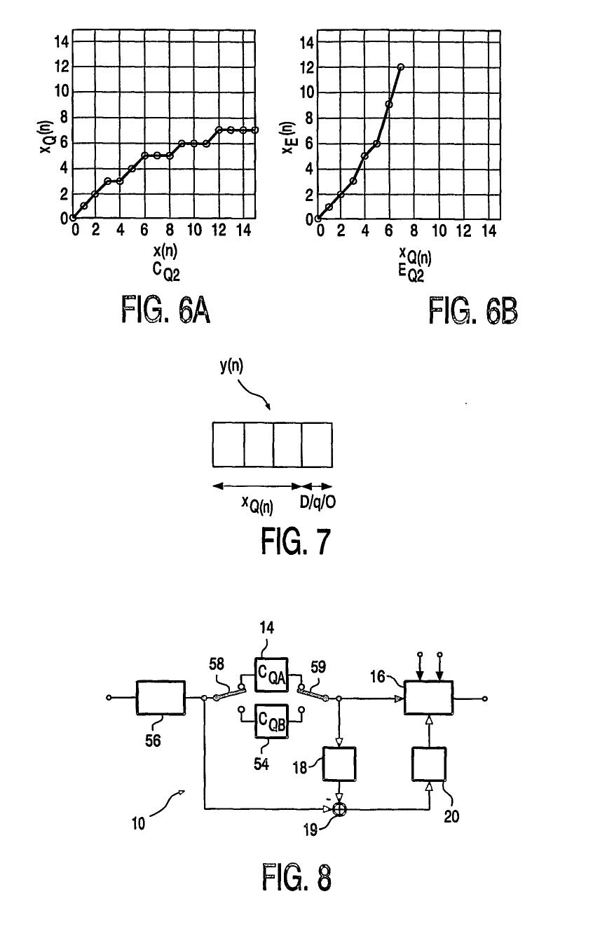

There are a number of variations that can be made, of which one variation according to a variation of the first embodiment of the invention is shown in a block schematic in FIG. 5. The only difference between this variation and the first described embodiment is that a first shifting unit 50 has been provided between the first mapping unit 14 and the multiplexing unit 16 and that a second shifting unit 52 has been provided between the demultiplexing unit 22 and the third mapping unit 24. Another difference is also that other first and second mapping functions are used. The first mapping function C_{Q2} used in the first mapping unit 14 is here a compressing function, while the second mapping function E_{Q2} used in the second and third mapping units 18 and 24 is here an expanding function, which functions are shown in the charts in FIGS. 6A-6B. This first mapping function maps an amplitude level zero onto a compressed level zero, an input amplitude level one is mapped onto an output amplitude level one, an input amplitude level two is mapped onto an output amplitude level two. An input amplitude level three is mapped onto an output amplitude level three while an input amplitude level four is also mapped onto the output amplitude level three. An input amplitude level five is mapped onto an output amplitude level four, while an input amplitude level six is mapped onto an output amplitude level 5. Also input amplitude levels seven and eight are mapped onto the output amplitude level six. Input amplitude levels nine, ten and eleven are mapped onto an output amplitude level six and input amplitude levels twelve, thirteen, fourteen and fifteen are mapped onto an output amplitude level seven. The first mapped output signal x_{Q} thus only has eight different possible low-level amplitude levels, while the high-level levels are not used. The second mapping function maps the input level zero onto an output level zero. The input level one is mapped onto an output level one, an input level two is mapped onto an output level two, an input level three is mapped onto an output level three, an input level four is mapped onto an output level five, an input level five is mapped onto an output level six, an input level six is mapped onto an output level nine and an input level seven is mapped onto an output level twelve. The first shifting unit 50 acts to shift the compressed audio signal x_{Q} p positions to the left, where p is one in the present case, i.e. multiplies the compressed signal samples with a factor of 2^{p}. In the same manner the second shifting unit 52 acts to shift the received input signal (after overhead, watermark and error signal have been removed) p positions to the right, i.e. performs a multiplication of 2^{-p}, which restores the compressed signal x_{Q}. In this system the audio signal is compressed such that the upper levels of the audio is left unused. The compressed signal is then shifted such that the least significant bits can be used for watermark, overhead and error signal. This greatly simplifies the insertion and extraction of this additional information. A signal y of a compressed sample according to this variation is outlined in FIG. 7, showing a four-bit signal or sample where the first three most significant bits are shown including the compressed sample x_{Q}(n) followed by one bit of watermark data D and/or error signal q and/or overhead O. All the added information is thus provided in the least significant bit of this signal y.

There are some variations of this basic part of the invention that are best mentioned here. First of all it has to be mentioned that if the first mapping function used has a one-to-one correspondence in the mapping of levels, there is no need for an error signal. In this special case and error signal and the processing associated with it is not necessary to include in the device. When this pre-requisite exists there is furthermore no need for the second mapping unit, the subtracting unit and the error compressing unit in the encoder and no adding unit and error expanding unit in the decoder. What is important then is however that the third mapping unit in the decoder uses a mapping function, which is the inverse of the first mapping function in the encoder. Such a situation might be present for audio or other types of media content, which do not have amplitude values in the upper half of the amplitude spectrum. Another possible variation in case an error signal is used, is that the second mapping function used does not have to be the inverse of the first mapping function. Another second mapping function can be used. In this case the difference would most certainly lead to larger error signals. The information in the error signal would also lead to a restoration of the original signal on the decoder side. The error signal can furthermore be left uncompressed, but this might lead to a reduction of the capacity for the embedded data channel. There does furthermore not have to be any overhead information provided in the transmitted signal y. The first mapped output signal does not have to provide a hole at even levels, but can just as well provide them at odd levels. It does furthermore not need to provide holes at all the even levels. In one variation it only provides one hole in the amplitude levels, where the original value is mapped onto another value, which does not have to be a value, which is a neighbouring value, even though this is preferred. In the same way the corresponding value to the hole used when inserting the additional bit of information does not have to be the next higher value, but it can also be a lower value or almost any other possible value of the mapped media content. It can be an advantage if this corresponding value is a value that is frequent in the mapped media content.

Some further aspects of the invention will in the following be described in relation to FIG. 8-10.

A second embodiment of the invention will now be described in relation to FIG. 8, which shows an encoder 12, which is basically the same encoder as was shown in FIG. 1. The differences in relation to the first embodiment are that a fourth mapping unit 54 is provided in parallel with the first previously described mapping unit 14. The first mapping unit 14 uses a first mapping function C_{QA}, while the fourth mapping unit 54 uses another first mapping function C_{QB}. Before this pair of mapping units 14 and 54 there is also provided a segmentation unit 56. A first switch 58 is provided between the segmentation unit 56 and the pair of mapping units 14 and 54 and a second switch 59 is provided between the pair of mapping units and the multiplexing unit 16 and the second mapping unit 18. The switches are switched in synchronism for connecting either of the first or fourth mapping units 14 and 54 to the second mapping unit 18 and the multiplexing unit 16. The first and fourth mapping units 14 and 54 here have two different functions which give different mapping results, where one might be provided for providing the highest possible capacity regarding how much additional data needs to be inserted, while the other might be better for minimizing perceptual distortion in the output signal y. Note that because of this the first mapping functions described in FIGS. 2 and 6 might not be suitable for these mappings, which is indicated by denoting the functions C_{QA} and C_{QB} instead of C_{Q1} and C_{Q2}. An input signal is furthermore segmented before it is provided to a mapping unit. Note that the encoder here uses the same second mapping function all the time. In this second embodiment it might be possible for a user to select different first mapping functions. Differences in the signal mapped by the third mapping unit because of different first mapping functions are taken care of by the error signal generated. The decoder is essentially the same in this second embodiment as the decoder shown in the first embodiment in that it does not include any extra functionality. The second mapping function used will most probably differ from the first embodiment, though. It is here preferable that the decoder uses the same second mapping function that the encoder uses. If small errors are allowed slight variations of the functions can be allowed for retrieving the original signal.

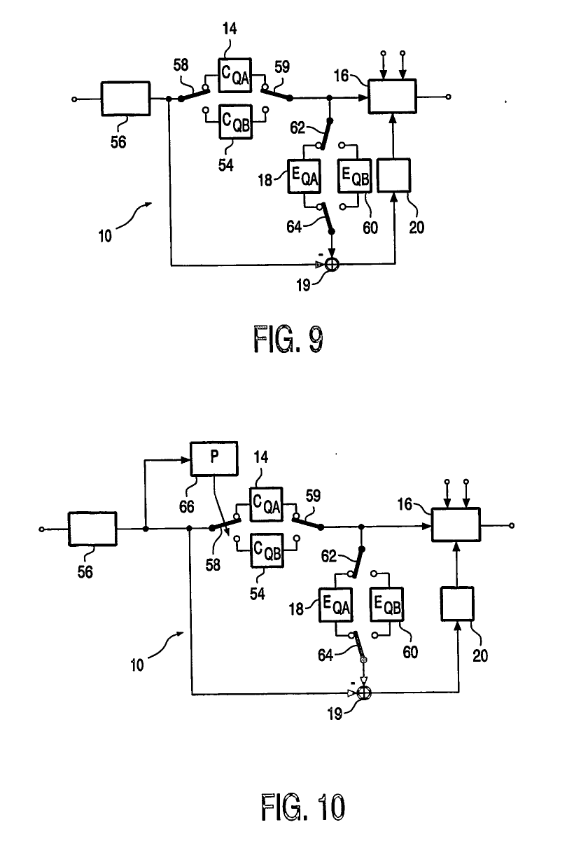

An encoder according to a third embodiment of the invention is shown in a block schematic in FIG. 9. There is mainly one difference between the third and the second embodiments, and that is that a fifth mapping unit 60 is provided in parallel with the second mapping unit 18. A third switch 62 is connecting the input of the multiplexing unit 16 with either of the second or fifth mapping units 18 and 60 and a fourth switch 64 is connecting either of the second or fifth mapping units 18 and 60 to the subtracting unit 19. The third and fourth switches are to be switched in synchronism with the first and second switches 58 and 59. The second mapping unit 18 provides a second mapping function E_{QA} which is to be used together with the first mapping function C_{QA}, while the fifth mapping unit 60 provides another second mapping function E_{QB} which is to be used together with the first mapping function C_{QB}. With this embodiment the second mapping functions are switched such that a second mapping function suitable for a selected first mapping function can be used. Here the selection of first and second mapping functions can for instance be made based on a random (possibly secret) key. This is advantageous since it reduces the error signals generated and therefore the watermark can be made to occupy more space in the transmitted signal. It is here necessary that the decoder also is provided with the same number of parallel second mapping functions for being able to switch between different mapping units in order to function properly. In order for the decoder to be able to perform this switching, information about the selection of second mapping function has to be transmitted from the encoder. It is also possible to transmit information about selected first mapping function instead, in which case the decoder can select second mapping function based on this information. It is also possible to send information about both the first and second mapping functions used in the encoder. This information can be provided in the overhead. The properties can as an alternative be determined from properties of the input signal y. The decoder does furthermore not have to use the same type of second mapping function as the encoder does, as long as the final scheme is reversible.

An encoder according to a fourth embodiment of the invention is shown in a block schematic in FIG. 10. The difference from the third embodiment is that a signal property extracting unit 66 is provided which analyses the input signal and controls the switches in order to select first mapping function and second mapping function in dependence on the properties of the signal. In this way an adaptive mapping scheme is provided that can select mapping function in dependence of the input signal or the different segments of the input signal. In case the signal is a video signal, different mapping functions can be used for different frames of the signal. The signal property extracting unit could also be combined with the second embodiment as well, i.e. without the fifth mapping unit

It should be realised that the decoder need not be performing the full decoding described above. In dependence of if the original signal need to be restored or not it might be sufficient to only remove the watermark and not restore the original signal at all. The restoration might furthermore be made incompletely so that a few errors are allowed, where the final restored signal might be estimated. The media content does furthermore not have to be provided in the form of audio, but the invention can be used on any type of media content including images and video. It is furthermore possible to select between more than two first and/or second mapping functions. The second mapping function in the decoder can furthermore be selected in response to the output signal x as an alternative to the properties of the signal y and the overhead information. The error signal need furthermore not be included in the signal y, but can be provided to the decoder in some other way, for instance in another signal, perhaps provided before sending the signal y. Yet another variation of the invention is that the encoder need not be sending the signal y to the decoder. It is also possible that the encoder stores this signal in a memory, which can be a portable memory like a CD ROM, from which the decoder could retrieve the signal. In this case the decoder would receive the signal from the memory instead of from the encoder.

The present invention has many advantages. It allows a higher degree of coding in a media stream, i.e. has a large possible data capacity for the additional information including the watermark. It also allows for flexible coding as well as avoids loss of information in the original media content.

1. Method of sending additional information in a signal (y) having media content comprising the steps of:
mapping the amplitude values of the media content (x) onto first new values using a first mapping function (C_{q}), (step 28), and
inserting the additional information (O, D) into the mapped media content (x_{Q}), (step 36).

2. Method according to claim 1, wherein the first mapping function creates at least one hole in the amplitude values of the mapped media content to be used for embedding additional information.

3. Method according to claim 2, wherein the step of inserting additional information comprises using said at least one hole and a corresponding value of the mapped media content for embedding additional data.

4. Method according to claim 1, wherein the step of mapping includes allowing the use of one first new value of the media content to correspond to more than one unmapped value of the original media content and further comprising the steps of:
mapping the first new values of the media content (x_{Q}) onto second new values using a second mapping function (E_{Q}), (step 30), and
generating an error signal (q) comprising the difference between the second new values of the media content (x_{E}) and the original media content (x), (step 32), and sending the error signal (q) to the receiver.

5. Method according to claim 4, further including the step of compressing the error signal (step 34).

6. Method according to claim 4, further comprising the step of sending the media content (x_{Q}) that has been mapped using the first mapping function together with the additional information (O, D) to a receiver (12), (step 38), wherein the error signal is included in the media content sent to the receiver.

7. Method according to claim 4, further comprising the steps of sending the media content (x_{Q}) that has been mapped using the first mapping function together with the additional information (O, D) to a receiver (12), (step 38), and sending information about first and/or second mapping function used to the receiver.

8. Method according to claim 7, wherein the information about second mapping function used is included in the media content sent to the receiver.

9. Method according to claim 1, further including the step of selecting a first mapping function among at least two first mapping functions and performing the step of mapping using the selected function for at least a part of the media content.

10. Method according to claim 9, wherein the step of selecting is performed in dependence of properties of the media content.

11. Method according to claim 9, further including the steps of:
selecting a second mapping function among at least two second mapping functions, mapping the first new values of the amplitude of the media content using the second mapping function onto second new values for parts of the media content mapped according to the selected first mapping function, and
generating an error signal comprising the difference between the second mapped media content and the original media content for the selected first and second mapping functions.

12. Method of receiving additional information in a signal having media content, comprising the steps of:
receiving a signal (y) including media content (x_{Q}) the amplitude values of which have been mapped onto first new values using a first mapping function (C_{q}) together with embedded additional information (O, D), (step 40), and
removing the additional information (O, D) from the media content, (step 42).

13. Method according to claim 12, further including the step of processing the additional information.

14. Method according to claim 12, further including the step of mapping the amplitude of the received first new values of the media content onto second new values using a second mapping function (E_{Q}), (step 44).

15. Method according to claim 14, further including the steps of receiving an error signal (q) corresponding to an error between the original media content (x) and media content (x_{E}) mapped with the second mapping function (E_{Q}) and adjusting the media content mapped using the second mapping function (E_{Q}) with the error signal, (step 48).

16. Method according to claim 14, further including the step of receiving first or second mapping function information and applying a second mapping function according to this information on at least parts of the received media content.

17. Device (10) providing additional information in a signal having media content, comprising:
a first mapping unit (14) arranged to map the amplitude values of the media content (x) onto first new values using a first mapping function (C_{q}), and
a multiplexing unit (16) for inserting the additional information (O, D) into the mapped media content.

18. Device according to claim 17, wherein the first mapping unit is arranged to create at least one hole in the amplitude values of the mapped media content to be used for embedding additional information.

19. Device according to claim 18, wherein the multiplexing unit is arranged to use said at least one hole and a corresponding value of the mapped media content for embedding additional data.

20. Device according to claim 17, farther comprising a second mapping unit (18) arranged to map the first new values of the media content (x_{Q}) onto second new values using a second mapping function (E_{Q}) and a subtracting unit (19) arranged to subtract the original media (x) content from the second new values of the media content (x_{E}) for providing an error signal (q).

21. Device according to claim 20, wherein the multiplexing unit (16) is arranged to insert the error signal in the first new values of the media content.

22. Device according to claim 17, wherein there are at least two mapping units (14, 54) performing two different first mapping functions and furthermore comprising a first switch (58) arranged to connect the original media content to either one of the first mapping units.

23. Device according to claim 22, further comprising at least two mapping units (18, 60) performing two different second mapping functions and each arranged to map first new values of the media content (x_{Q}) onto second new values, a subtracting unit (19) arranged to subtract original media content (x) from second new values of the media content (x_{E}) for providing an error signal (q), a further switch (62) arranged to connect the first new values of the media content to either one of the mapping units performing a second mapping function and yet a further switch (64) arranged to connect either one of the mapping units performing a second mapping function to the subtracting unit.

24. Device (12) for receiving additional information (O, D) in a signal (y) having media content, comprising:
a demultiplexing unit (22) arranged to:
receive a signal (y) including media content the amplitude values (x) of which have been mapped onto first new values (x_{Q}) using a first mapping function (C_{q}) together with embedded additional information (O, D), and
remove the additional information from the media content.

25. Device according to claim 24, further comprising:
an third mapping unit (24) arranged to map the the first new values of the received media content to second new values using a second mapping function (E_{Q}).

26. Device according to claim 25, further comprising an adding unit (27) arranged to add a received error signal (q) to the second new values of the media content (x_{E}) for providing at least essentially lossless media content.

27. System of devices that can communicate with each other comprising:
a device (10) providing additional information (O, D) in a signal (y) having media content, comprising:
a first mapping unit (14) arranged to map the amplitude values of the media content onto first new values using a first mapping function (C_{q}), and
a multiplexing unit (16) for inserting the additional information into the mapped media content, and
a device (12) for receiving additional information (O, D) in a signal (y) having media content, comprising:
a demultiplexing unit (22) arranged to receive a signal including media content (x_{Q}) the amplitude values of which have been mapped onto first new values using said first mapping function (C_{q}) together with additional embedded information (O, D), and remove the additional information from the media content.

28. Signal (y(n)) comprising media content (x_{Q}(n)) with embedded additional information (O;D), where the amplitude values of the media content have been mapped onto first new values using a first mapping function (C_{q}), such that the additional information can be retrieved from the mapped media content.
